(19) United States
(12) Patent Application Publication
(10) Pub. No.: US 2026/0023536 A1
(43) Pub. Date: Jan. 22, 2026

(54) THREAT MODEL ASSISTANT FOR SOFTWARE DEVELOPMENT

(71) Applicant: American Express Travel Related Services Company, Inc., New York, NY (US)

(72) Inventors: John Thomas Hancock, III, Deerfield Beach, FL (US); Hiranmayi Palanki, Tampa, FL (US)

(21) Appl. No.: 18/776,980

(22) Filed: Jul. 18, 2024

(51) Int. Cl. G06F 8/35; G06F 8/10; G06F 8/71; G06F 11/36; G06F 16/33

(52) U.S. Cl. CPC G06F 8/35; G06F 8/10; G06F 8/71; G06F 11/3684; G06F 11/3688; G06F 16/3338

(57) ABSTRACT

The present disclosure of the various embodiments relates to using a large language model to assistant with the creation of secure code and/or the completion of threat modeling tasks in software development. In one example, a system comprises a computing device configure to identify a prompt that requests generating secure source code for source code with a security vulnerability. A security data source is queried for a security threat embedding. The security threat embedding is received from the security data source and an augmented prompt is generated. The augmented prompt is transmitted to the large language model. A secure source code is received from the large language model and imported into application source code in a software development environment.

### BACKGROUND

Often, developer teams building enterprise applications assign a team member to evaluate security threats for the source code. The team member may use one or more threat modeling tools to assist with identifying security vulnerabilities for the enterprise applications. After being identified, the team member can modify the source code to address the security vulnerabilities.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a pictorial diagram of a first example user interface according to various embodiments of the present disclosure.

FIG. 2 is a drawing of a network environment according to various embodiments of the present disclosure.

FIG. 3 is a pictorial diagram of a second example user interface displayed by a client device in the network environment of FIG. 2 according to various embodiments of the present disclosure.

FIG. 4 is a sequence diagram illustrating one example of functionality for the operations executed in the network environment of FIG. 2 according to various embodiments of the present disclosure.

FIG. 5 is a flowchart illustrating one example of functionality implemented as portions of a client application executed in a client device in the network environment of FIG. 2 according to various embodiments of the present disclosure.

FIG. 6 is a flowchart illustrating another example of functionality implemented as portions of a developer service executed in a computing environment in the network environment of FIG. 2 according to various embodiments of the present disclosure.

### DETAILED DESCRIPTION

The various embodiments of the present disclosure relate to using a large language model to assist with the creation of secure code and/or the completion of threat modeling tasks in software development. Often, while building a software application, a developer may not consider the best practices for implementing security features. As a result, another developer will be tasked with analyzing the software architecture and/or the source code for security vulnerabilities and writing code that implements various security features for addressing the identified security vulnerabilities. In many cases, developers use one or more threat modeling tools to assist with the security analysis of the software architecture and/or source code. However, the process of identifying these securing vulnerabilities after the development of the software application and implementing security requirements into the software application subsequently can be a time intensive process. Further, the incorporation of security requirements after the design of the software application may lead to a less effective application design from a software security perspective because the security requirements were not considered during the design phase.

Accordingly, the various embodiments of the present disclosure provide various advantages over exiting threat modeling software development tools. The various advantages enable developers to develop software applications with improved security features during a software design phase and enable developers to reduce the amount of time needed for software development.

In some examples, the various embodiments can generate secure source code by providing a trained large language model (LLM) with security requirements, in which the security requirements can be provided in a prompt as text or as an image. The large language model can be integrated into a software development platform, such as an integrated development environment. In some instances, the secure code is generated in an iterative manner with the developer. Each iteration with the LLM can be directed to a different architectural component of the software application in the context of a threat model analysis.

For example, the various embodiments can generate security test cases to ensure the generated secure code meets the security requirements provided by the developer. The LLM can be instructed to determine whether the security requirements have been implemented in the source code. Further, the various embodiments can use a threat model dataset to fine-tune LLMs on image recognition tasks for the threat-based security requirements.

In some examples, the various embodiments can use a retrieval augmented generation protocol for reducing model hallucinations (e.g., errors or misleading results generated from LLM services/applications). Further, the various embodiments can include an end-to-end automation flow for injecting the LLM generated code into a software development environment and for providing assistance with other tasks throughout the software development lifecycle. For example, the developer can interact with the LLM for assistance with various stages in the software development process, such as testing source code, storing source code in a code repository, building source code, releasing source code to production, and other suitable software development operation stages.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

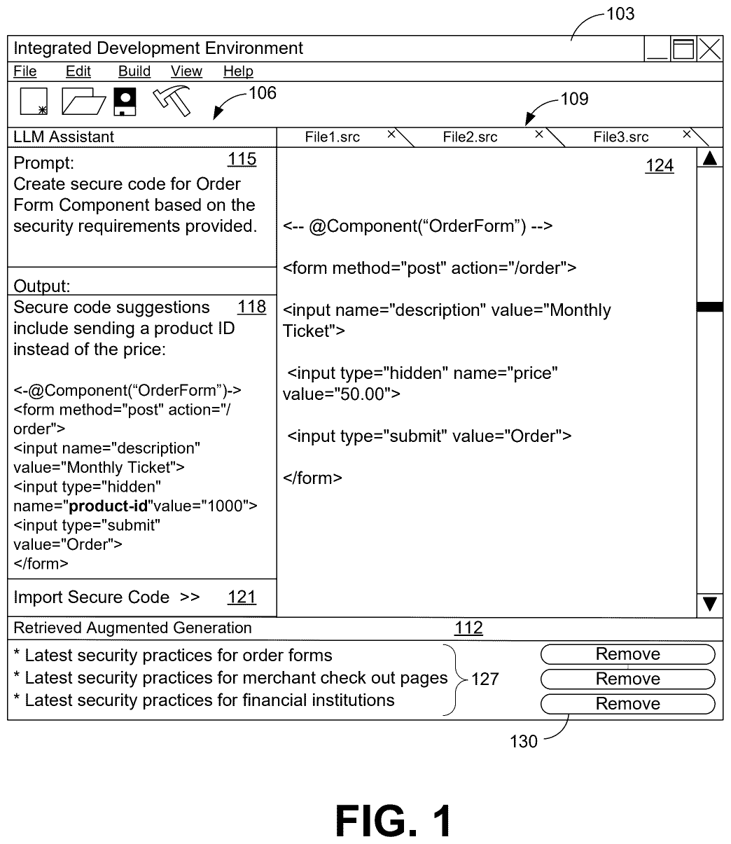

With reference to FIG. 1, shown is an example of a user interface 103 for a software development environment (e.g., an integrated development application) of a user (e.g., a developer). The user interface 103 includes a large language model (LLM) assistant section 106, a source code editor section 109, a retrieval augment generation section 112, and other suitable components.

The LLM assistant section 106 can be used to enter LLM prompts for a LLM service and receive LLM responses from the LLM service. The LLM service (an LLM application) can represent a large language model that is executed for natural language processing tasks. The LLM assistant section 106 includes a prompt section 115, an output section 118, an import secure code component 121, and other suitable components. The prompt section 115 can be an area for a user to enter a LLM prompt for the LLM service. The prompt section 115 can be configured to receive the prompt as text, an image, and other suitable formats. The prompt can represent an instruction for the LLM service. The instructions can be used for various tasks associated with security threat modeling, source code generation, and other suitable software development tasks.

The output section 118 can be used to receive a response from the LLM service. In FIG. 1, the output section 118 includes a response that includes a suggested source code modification to source code in the source code editor section 109. The suggested modification includes a modification for improving the security of the source code. The import secure code component 121 can be selected by the user for importing secure source code from the output section 118 into the source code editor section 109.

The source code editor section 109 can be an area for a user to enter source code. In some instances, the user can highlight or select portions of the source code for security analysis by the LLM service in combination with the prompt entered into the prompt section 115.

The retrieval augment generation section 112 can be used to display one or more retrieved documents or embeddings from a security data source (e.g., threat intelligence data source). The retrieved documents can be retrieved based at least in part on an entered prompt. In some examples, the retrieved documents can be submitted to the LLM service in combination with the prompt. In some examples, the user can review the retrieved documents before they are combined with the prompt. As such, the user can select one or more retrieved documents to be removed from the augmentation process.

As shown in FIG. 1, the user (e.g., a developer) has entered source code 124 in the source code editor section 109, in which FIG. 1 displays a section entitled “OrderForm.” The user enters a prompt that request that the LLM service create secure code for the “Order Form” portion of the source code 124. After submitting the prompt, the software development environment initiates a retrieval augment generation, which involves submitting a query to a security data source for relevant security embedding 127 (e.g., the latest security files, security documents, etc.) based at least in part on the prompt. From the security data source, the query can return a set of relevant security embedding 127 for augmenting the prompt. The security data source can be queried because it is updated more frequently than the LLM service is trained with new security threat data.

As shown in FIG. 1, the user can review the relevant security embedding 127 and remove one or more relevant security embeddings 127 that are not relevant to the prompt using the remove component 130. In some examples, after a review of the relevant security embeddings 127, the user can trigger the software development environment to augment the prompt with the relevant security embeddings 127 and submit the augmented prompt to the LLM service.

The output section 118 of the user interface 103 displays a response from the LLM service. The response is received based at least in part on the augmented prompt being submitted to the LLM service. The user can review the secure code displayed in the output section 118. If the user approves, the user can select the import secure code component 121 to have the secure code imported into the source code 124.

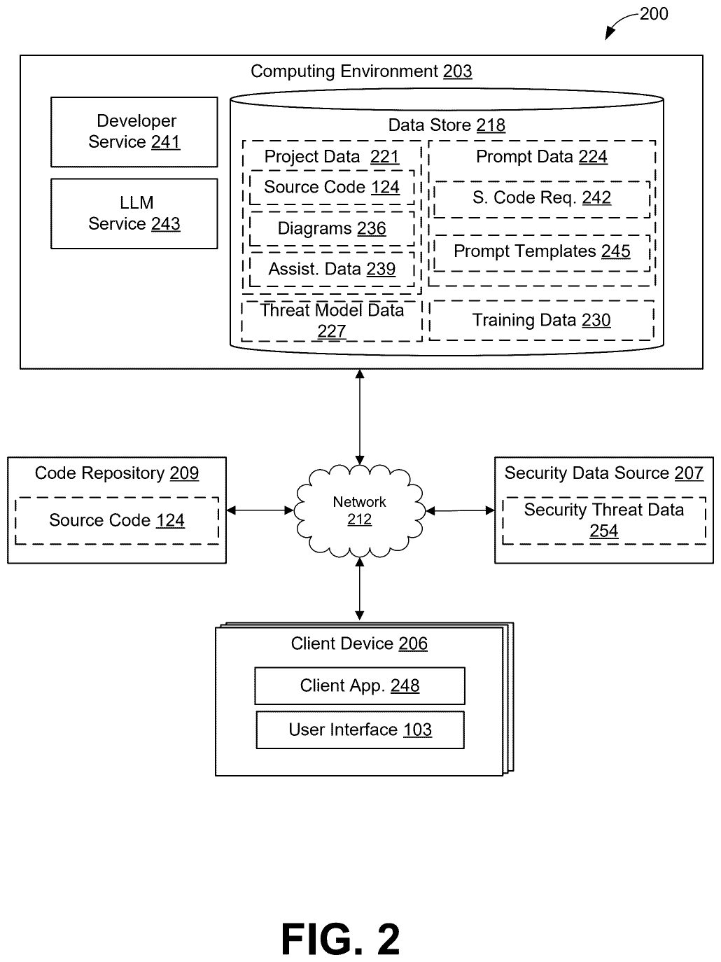

With reference to FIG. 2, shown is a network environment 200 according to various embodiments. The network environment 200 can include a computing environment 203, a client device 206, a security data source 207, and a code repository 209, which can be in data communication with each other via a network 212.

The network 212 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 212 can also include a combination of two or more networks 212. Examples of networks 212 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various data is stored in a data store 218 that is accessible to the computing environment 203. The data store 218 can be representative of a plurality of data stores 218, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 218 is associated with the operation of the various applications or functional entities described below. This data can include project data 221, prompt data 224, threat model data 227, training data 230, and potentially other data.

The project data 221 can represent data associated with one or more projects (e.g., development of a software application) during software development. The project data 221 can include source code 124, diagrams 236, assistant data 239, and other suitable data.

The source code 124 can represent text in a human-readable programming language, which can be translated to a machine readable code for the execution of a set of computing instructions. The source code 124 can be developed for implementing a software application.

The diagrams 236 can represent data for an architecture diagram of a software application, which can be used to generate a visual representation of the components of the software application. The diagrams 236 can be used for security threat assessments. The diagrams 236 can be an image or a programmatic representation (e.g., JavaScript-based diagramming, other suitable diagramming programming language, etc.). The assistant data 239 can represent data associated with a history of LLM prompts, security threat data 254, LLM responses, and other suitable data associated with a project and/a user (e.g., a software developer user). In some instances, the assistant data 239 can periodically be used as training data 230 for LLMs.

The prompt data 224 can represent data associated with the prompts and responses (e.g., displayed in an output section 118). Data associated with the prompts can include the text for the prompt submitted by the user and/or augmented embeddings retrieved from the security data source 207. The prompt data 224 can also include security code requirements 242 and prompt templates 245.

The security code requirements 242 can represent security restrictions, security criteria, a security policy for a software application, or other suitable means for specifying security code requirements 242. The security code requirements 242 can be specified by the user in a prompt to the LLM service 243. The security code requirements 242 can also be configured or identified in association with a source code 124. The security code requirements 242 can represent a specific set of security requirements for a software application or a component of the software application.

Some non-limiting examples of security code requirements 242 can include requirements such as not storing sensitive data like credentials in source code, not storing sensitive information in a client-side data storage, not using insecure JavaScript methods, not using the Window.alert( ) JavaScript function in production code, and other suitable security code requirements or limitations.

The prompt template 245 can represent defined prompt text that can be recognized by the LLM service 243 in order to perform a function. In some examples, a prompt template 245 can be used by the user in order to have the LLM service 243 perform a specific security task, such as application diagram generation, code review, code-to-diagram linkage tasks, and other suitable tasks. In other examples, the prompt templates 245 may be omitted. In these scenarios, the LLM service 243 is fine-tuned to understand instructions for executing a specific security threat task for software development.

The threat model data 227 can represent data associated with a security threat repository. The threat model data 227 can represent a data repository that stores various security code restrictions 242, security criteria, and other suitable security guidelines associated with an organization.

The training data 230 can represent data associated with fine turning one or more models used by the LLM service 243. The training data 230 can include datasets for generating, validating, evaluating and deploying models. The training data 230 can be used for fine-tuning the models for specific tasks, such as identifying security vulnerabilities in source code, image recognition tasks for security code requirements, generating application diagrams from an LLM prompt (e.g., generating diagram from prompt text, prompts for transforming or altering a diagram, etc.), source code review for responding with secure equivalent of source code with vulnerabilities to threat, establishing source code-to diagram linkage (e.g., the highlighted portion of the source code implements the “product selection” component in the diagram), and other suitable tasks. The training data 230 can include one or more datasets of labeled examples as prompt-response pairs. The datasets can be used to update the weights of one or more parameters of the models for the LLM.

Also, various applications or other functionality can be executed in the computing environment 203. The components executed on the computing environment 203 include a developer service 241, a large language model (LLM) service 243, and other applications, services, processes, systems, engines, or functionality not discussed in detail herein.

The developer service 241 can be executed to facilitate the creation of secure code and/or execute other security threat modeling tasks in a software development environment. The developer service 241 can be in data communication with the LLM service 243 and the client device 206. The developer service 241 can provide data for executing functionality relating to a software development environment (e.g., integrated development environment), a security threat modeling tool, an application diagraming tool, and other suitable functions to the client device 206.

In some examples, upon receiving a LLM prompt, the developer service 241 can perform a search query at the security data source 207 for relevant security threat data 254 for augmenting the LLM prompt. In other examples, the LLM service 241 can perform the search query at the security data source 207. In either of these examples, the search query can involve using a retrieval-augmented generation protocol.

The LLM service 243 can represent a large language model that is executed for natural language processing tasks. In some examples, the LLM service 243 can include a large language model that utilizes a transformer model that includes feed forward layers, embedding layers, encoding layers, attention layers, and/or other suitable components. In some examples, the LLM service 243 can include a large language model that utilizes other architectural approaches (e.g., recurrent neural networks, long short-term memory networks, etc.). The LLM service 243 can use a large language model prompt for generating a general-purpose language response. The large language model prompt can represent one or more statements (e.g., a series of text characters) or an image that provide one or more instructions for the LLM service 243 to execute.

The LLM service 243 can be executed to use a large language model for receiving instructions and providing responses to the developer service 241 and/or the client application 248. The large learning models used by the LLM service 243 can be trained (e.g., fine-tuning), evaluated, validated, and deployed for security threat modeling tasks in a software development environment. For example, the large learning models can be fine-tuned for reviewing source code for security vulnerabilities, generating a version of secure code for existing source code, generating application diagrams from a LLM prompt of text, generating code-to-diagram linkages between an application diagram and source code in a source code editor, and other suitable security threat modeling tasks in software development.

In some examples, the large learning models can be fine-tuned (e.g., trained for a specific software security task) using a training dataset of labeled examples as prompt-response pairs. For instance, code review functionality can be fine-tuned by providing labeled examples of prompts with unsecure source code and responses with versions of secure code.

In some examples, the LLM service 243 can be in direct communication with the client application 248. As such, the client application 248 can transmit LLM prompts to the LLM service 243 and the LLM service 243 can transmit a response to the client application 248. For example, the user interface 103 can include a LLM assistant section (e.g., FIG. 1 (106)) for interfacing with the LLM service 243 and the security data source 207.

The client device 206 is representative of a plurality of client devices 206 that can be coupled to the network 212. The client device 206 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 206 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 206 or can be connected to the client device 206 through a wired or wireless connection.

The client device 206 can be configured to execute various applications such as a client application 248 or other applications. The client application 248 can be executed to facilitate the functionality of the developer service 241 and/or the LLM service 243 on the client device 206. In some examples, the client application 248 can represent one or a combination of an integrated development environment application, a threat modeling application, a diagramming application, and other suitable software development applications.

In some examples, upon the entry of a LLM prompt, the client application 248 can perform a search query at the security data source 207 for relevant security threat data 254 for augmenting the LLM prompt. The search query can involve using a retrieval-augmented generation (RAG) approach. After the security threat data 254 has been retrieved, the client application 248 can generate an augmented prompt and transmit the augmented prompt to the developer service 241 and/or the LLM service 243.

The client application 248 can be executed in a client device 206 to access network content served up by the computing environment 203 or other servers, thereby rendering a user interface 103 on the display. To this end, the client application 248 can include a browser, a dedicated application, or other executable, and the user interface 103 can include a network page, an application screen, or other user mechanism for obtaining user input. In some examples, the user interface 103 can display in a single view or multiple views components of an integrated development environment, a threat modeling application, an architecture diagramming application, and other suitable software development applications. The client device 206 can be configured to execute applications beyond the client application 248 such as email applications, social networking applications, word processors, spreadsheets, or other applications.

The security data source 207 can represent a computing storage device for storing a latest version of security threat data 254. The security data source 207 can represent an authoritative security threat knowledge base of security threat data 254 outside of the training data 230. The security threat data 254 can include data associated with latest security facts, best practices, techniques, and other suitable data. The security threat data 254 can be retrieved in order to ensure the LLM service 243 has the most accurate data for the requested instruction. In some examples, the security data source 207 can be integrated within the computing environment 203.

The security data source 207 can be used in a retrieval-augmented generation process. The security data source 207 can be used for responding to a query from the developer service 241 for relevant data relating to a prompt and/or security code requirements 242 submitted by the user. The retrieved security threat data 254 can be used for augmenting a prompt before the prompt is sent to the LLM service 243. The security threat data 254 can include security documents, security data, images, files and suitable data that can be represented as security threat embeddings (e.g., a numeric representation of a document which can be processing by a LLM). The security threat embeddings can represent a conversion of the data into a numerical representation that is stored as vector data.

The code repository 209 can represent a computing storage device for storing one or more versions of the source code 124 (e.g., application source code). Each version of the source code 124 may represent a milestone for the source code 124. In some examples, the source code 124 can be stored into the code repository 209 after a commit instruction has been initiated by the developer service 241 and/or the LLM service 243. In some examples, the code repository 209 can be integrated within the computing environment 203.

Next, a general description of the operation of the various components of the network environment 200 is provided. To begin, a user may be a software developer that is working on developing a software application in the client application 248 (e.g., integrated development environment application). The client application 248 has source code 124 for the software application. The client application 248 can have a user interface 103 with an LLM assistant section 106 (see e.g., FIG. 1). The user can enter a LLM prompt into the prompt section 115. For example, the user can enter an LLM prompt with an instruction to review the source code 124 and generate a version of secure code for the source code 124. The prompt can be submitted with security code requirements 242. The security code requirements 242 can be specified in the prompt section 115 or can be configured as settings at a different time.

Upon receiving the LLM prompt, the developer service 241 can generate and submit a query to a security data source 207 for relevant security threat data 254 (e.g., latest security documents, security data, etc.) associated with the LLM prompt. The developer service 241 can generate an augmented LLM prompt with the retrieved security threat data 254 in order to improve the accuracy of a response from the LLM service 243. The augmented prompt can be used to reduce hallucinations (e.g., incorrect or misleading results) produced by the LLM service 243.

After the augmented LLM prompt is generated, the developer service 241 can transmit the augmented LLM prompt to the LLM service 243. In response, the LLM service 243 can transmit to the developer service 241 a response that includes generated secure source code for the selected source code in the client application 248. The LLM service 243 can generate the secure source code based at least in part on the secure code requirements 242 and/or the retrieved security threat data 254 (e.g., security documents, security files) from the security data source 207.

The developer service 241 can transmit the generated secure code to the client application 248 for display. The LLM response can include a text explanation to explain the secure code to the user. After the reviewing the secure code, the user can use the client application 248 to import the generated secure code into the existing source code 124.

Subsequently, in some examples, the user can enter into the prompt section 115 a request for security test cases to evaluate whether the security code requirements 242 have been implemented in the secure code. Similar to the request for secure code, the developer service 241 can submit a query to the security data source 207 for relevant security threat data 254 (e.g., relevant security test documents or security test data) based at least in part on the security code requirements 242 and/or the prompt for security test cases.

Upon retrieving the relevant security data 254, the developer service 241 can generate and transmit the augmented prompt to the LLM service 243. The LLM service 243 can transmit to the developer service 241 security test cases that can be executed to evaluate the secure source code. The user can evaluate the test results from the test security cases. Further, in some examples, another additional LLM prompt can be transmitted to the LLM service 243 to evaluate whether the security code requirements 242 have been implemented. In some implementations, upon confirming the implementation of the security code requirements 242, the LLM service 243 can initiate subsequent software development operations, such as committing the secure code to the code repository 209, building the secure source code, and releasing secure code to production.

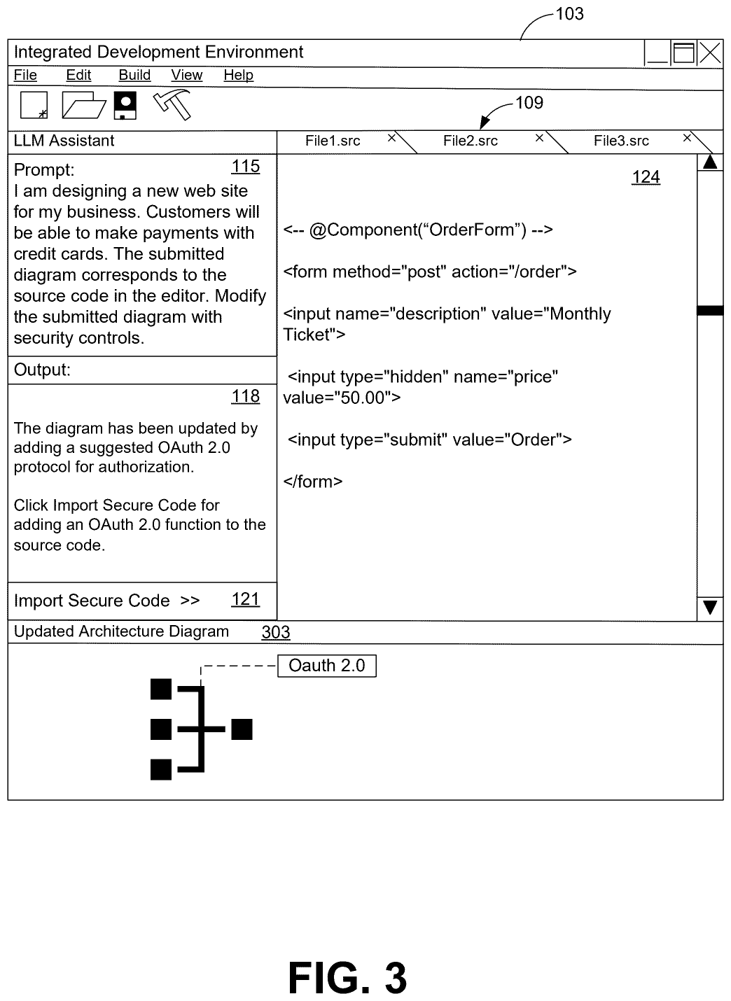

Referring next to FIG. 3, shown is another example of a user interface 103 of the client application 248, which is displaying data from the developer service 241. In FIG. 3, the user interface 103 can include a prompt section 115, the output section 118, source code editor section 109, and a diagram section 303. Further, the prompt section 115 has text for a prompt that indicates the user is designing a new website. The prompt can indicate that a diagram has been submitted by the user and that it corresponds to the source code 124 in the source code editor section 109. Further, the prompt can include an instruction for modifying the submitted diagram with security controls (e.g., security code requirements 242).

In response, the user interface 103 can include an output section 118 with a LLM response. The LLM response can indicate the diagram has been modified by including a recommended security control for an OAuth 2.0 protocol for authorization. The LLM response can indicate that the source code 124 in the source code editor section 109 can be modified to include secure code for the implementing the OAuth 2.0 protocol by selecting the import secure code component 121.

Further, the diagram section 303 can include a modified diagram generated by the LLM service 243. The modified diagram can include dashed lines to represent a location for implementing the OAuth 2.0 protocol. The indicated location can represent an implementation location between two software components in the architecture of the software application.

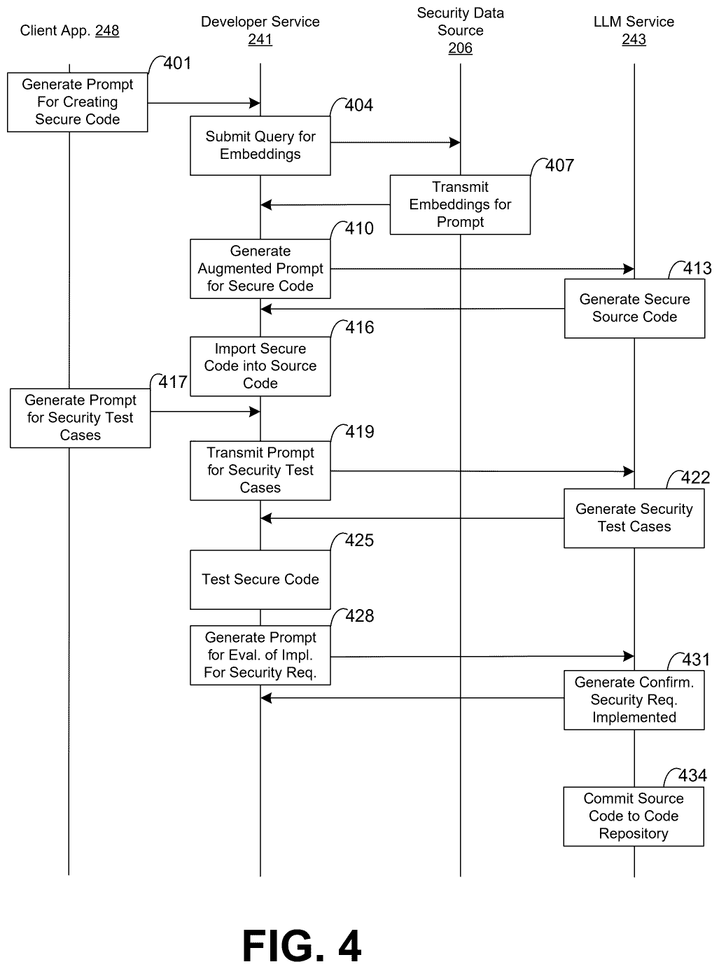

Turning now to FIG. 4, shown is a sequence diagram that provides one example of the operation of a portion of the network environment 200. The sequence diagram of FIG. 4 provides merely an example of the many different types of functional arrangements that can be employed to implement the operation of the depicted portion of the network environment 200. As an alternative, the sequence diagram of FIG. 4 can be viewed as depicting an example of elements of a method implemented within the network environment 200.

Beginning with block 401, the client application 248 can be used by a user to generate a LLM prompt for generating secure source code for source code 124 of a software application. The LLM prompt can be associated with a set of security code requirements 242, which can be considered in the generation of the secure source code. In some examples, the security code requirements 242 can be selected based at least in part on access to the threat model data 227. The LLM prompt and the security code requirements 242 can be transmitted to the developer service 241.

In some examples, the LLM prompt and security code requirements 242 can be entered into the client application 248 by the user. In some instance, the security code requirements 242 can be selected from the threat model data 227.

In block 404, the developer service 241 can submit a query for security threat data 254 (e.g., security threat embeddings) to the security data source 207 in order to optimize the output of the LLM service 243. The developer service 241 can query the security data source 207 in order to retrieve the latest documents and/or data relevant to the security code requirements 242 and the LLM prompt. The security data source 207 may be updated more frequently than the language learning models used by LLM service 243 can be trained. In some instances, the developer service 241 can execute a retrieval-augmented generation process with the security data source 207.

In block 407, security data source 207 can transmit security threat data 254 (e.g., embeddings, relevant documents, and/or other suitable relevant data) based at least in part on the prompt and/or the security code requirements 242. In some examples, the security threat data 242 comprises security threat embeddings, which can be a numeric representation of a document or other data that captures the semantic properties of a document or data in a way that can be processed by a language learning model. In some instances, the security threat embeddings are generated using an embedding language model, in which the embeddings are stored in a vector database.

In block 410, the developer service 241 can generate an augmented prompt based at least in part on the retrieved security threat data 254 and the security code requirements 242. In some examples, the augmented prompt is generated by adding the security threat data 254 (e.g., the security threat embeddings) in a context for the LLM service 243. After being generated, the developer service 241 can transmit the augmented prompt to the LLM service 243.

In block 413, the LLM service 243 can generate secure source code based at least in part on the augmented prompt. The LLM service 243 can transmit the secure source code to the developer service 241, which can also be transmitted to the client application 248 for display on the client device 206. The user can review the secure source code and other response data (e.g., a text explanation of the secure source code) provided in the user interface 103. In some examples, after reviewing the secure source code, the client application 248 can instruct the developer service 241 to import the secure source code into the existing source code 124.

In block 416, the developer service 241 can import the secure source code generated by the LLM service 243 based at least in part on receiving an instruction to import the secure source code from the client application 248. The developer service 241 can transmit data to the client application 248 for updating the source code 124 displayed in the user interface 103 to include the secure source code.

In block 417, the client application 248 can be used by a user to generate a LLM prompt for creating secure test cases for source code 124 of a software application. The client application 248 can transmit the LLM prompt to the developer service 241.

In block 419, the developer service 241 can transmit the LLM prompt to the LLM service 243 for the generation of security test cases. The developer service 241 can receive the LLM prompt from the client application 248 for generating a security test case for the secure source code. In some examples, the developer service 241 can submit a query to the security data source 207 for security threat data 254 for augmenting the prompt for generating security test cases (e.g., a retrieval-augmented generation process). The retrieved security threat data 254 can be related to the security code requirements 242 and/or the prompt for generating security test cases. After being retrieved, the developer service 241 can augment the prompt with the security threat data 254.

Alternatively, in some examples, the client application 248 can query the security data source 207 for relevant embeddings and augment the LLM prompt with the relevant embedding. The client application 248 can transmit the augmented prompt to the LLM service 243.

In block 422, the LLM service 243 can generate one or more security test cases based at least in part on the LLM prompt, the security code requirements 242 and/or the security threat data 254. The LLM service 243 can transmit the security test cases to the developer service 241. The developer service 241 can transmit the security test cases to the client application 248 for display in the user interface 103. In some examples, the client application 248 can transmit instructions for initiating an execution of the security test cases for the secure source code.

In block 425, the developer service 241 can execute one or more of the test security cases for evaluating the secure source code. The developer service 241 can initiate the execution based at least in part on an instruction transmitted by the client application 248. After security test cases has been executed, the developer service 241 can generate the test results and transmit them to the client application 248 for display.

In block 428, the developer service 241 can generate an LLM prompt for instructing the LLM service 243 to evaluate whether the security code requirements 242 have been implemented in the secure source code. The developer service 241 can transmit the prompt to the LLM service 243. In some examples, the client application 248 can transmit a LLM prompt to the developer service 241, and the developer service 241 can query the security data source 207 for security threat data 254 (e.g., security threat embeddings) based at least in part the LLM prompt and/or the security code requirements 242. Upon receiving the security threat data 254 from the security data source 207, the developer service 241 can augment the prompt with the security threat data 254, and transmit the augmented prompt and/or the security code requirements 242 to the LLM service 243.

In block 431, the LLM service 243 can evaluate the secure source code based at least in part on the security code requirements 242. If the LLM service 243 determines that the security code requirements 242 have been implemented, the LLM service 243 can generate and transmit to the developer service 241 a confirmation that the security code requirements 242 have been implemented.

In block 434, LLM service 243 can execute a commit instruction for storing the secure source code at the code repository 209. In some examples, the developer service 241 can execute the commit instruction for storing the secure source code at the repository. In some examples, the developer service 241 and/or the LLM service 243 can be used to assist with other stages of software development operations, such build source code, release to production, and other suitable stages.

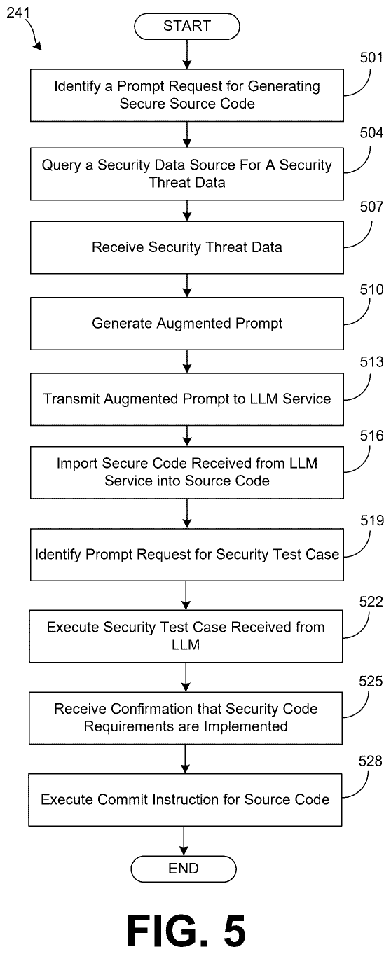

Moving on to FIG. 5, shown is a flowchart that provides one example of the operation of a portion of the developer service 241. The flowchart of FIG. 5 provides merely an example of the many different types of functional arrangements that can be employed to implement the operation of the depicted portion of the developer service 241. As an alternative, the flowchart of FIG. 5 can be viewed as depicting an example of elements of a method implemented within the network environment 200.

Beginning with block 501, the developer service 241 can identify a prompt request for generating secure code for selected source code 124 with a security vulnerability. The prompt request can be associated with a security code requirements 242. The developer service 241 can identify the prompt request based at least in part on a selection or entry of data into the user interface 103 displayed on the client device 206.

In some examples, the developer service 241 can receive the security code requirements 242 from the client application 248. In other instances, the security code requirements 242 can be associated with the source code (e.g., a setting associated with project data 221).

In block 504, the developer service 241 can transmit a search query to the security data source 207 for security threat data 254 associated with the prompt and/or the security code requirements 242. The search query can assist with retrieving the latest relevant security documents, security policies, security guidelines, and other suitable security data related to the prompt from the security data source 207. In some examples, the developer service 241 can execute a retrieval-augmented generation process. In some examples, the retrieved security threat data 254 has been converted to an embedding using an embedding language model, in which the embedding are stored in a vector database.

In block 507, the developer service 241 can receive the security threat data 254 from the security data source 207. The security data source 207 can be updated more frequently than a large learning model for the LLM service 243. In some examples, the developer service 241 can receive an indication of the last time the security threat data 254 has been updated or a schedule for the next update. As such, the developer service 241 may omit a query to the security data source 207 in cases when it is aware that the security data source 207 has not been omitted since a previous query.

In block 510, the developer service 241 can generate an augmented prompt based at least in part on the security threat data 254 retrieved from the security threat data 254. The developer service 241 can transmit the security data source 207 to the client application 248 for display. In some examples, the user may select to remove one or more of the documents or data elements retrieved from the security data source 207. After receiving a selection or a removal of particular security threat data 254, the developer service 241 can combine the selected security threat data 254 with the prompt.

In block 513, the developer service 241 can transmit the augmented prompt to the LLM service 243. In response, the LLM service 243 can generate secure code based at least in part on the source code and the augmented prompt. The developer service 241 can transmit the generated secure code and an explanation for the generate secure code to the client application 248 for display on the client device 206. In some instances, the secure code may be displayed with a visual indicator to indicate the differences in the secure code from the source code in a software development environment.

In block 516, the developer service 241 can import the secure code from the LLM service 243 into the source code 124 of the software development environment. After the import has been completed, the client application 248 can update the source code to include the secure code in the software development environment.

In block 519, the developer service 241 can identify a prompt request for a generation of a security test case. The developer service 241 can identify the prompt request based at least in part on an input provided to the user interface 103. In response, the LLM service 243 can generate the security test case and transmit it to the developer service 241.

In block 522, the developer service 241 can execute the security test case based at least in part on input received from the user interface 103. The developer service 241 can transmit data to the client application 248 for display in the user interface 103, which can display test results and analysis generated from the security test case.

In block 525, the developer service 241 can receive confirmation that the security code requirements 242 are implemented based at least in part on the test security case results and/or another examination of the source code 124. In some instances, the developer service 241 can transmit the confirmation to the client application 248 for display.

In block 528, the developer service 241 can execute a commit instruction for the source code based at least in part on the confirmation of the implementation of the security code requirements 242. The developer service 241 can store the source code 124 at the code repository 209. In some examples, the LLM service 243 can execute the commit instruction after a determination that the security code requirements 242 have been met. Then, the developer service 214 proceeds to the end.

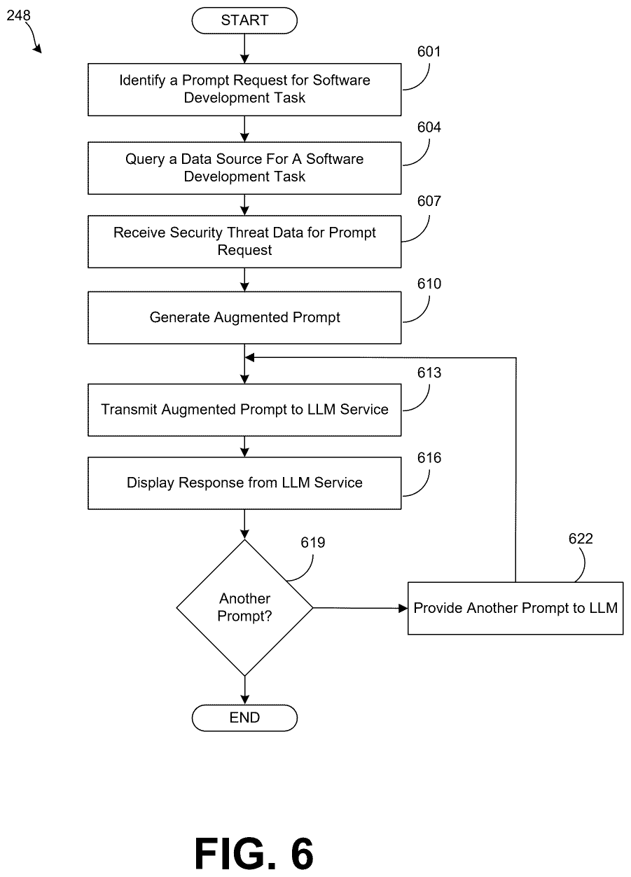

Referring next to FIG. 6, shown is a flowchart that provides one example of the operation of a portion of the client application 248. The flowchart of FIG. 6 provides merely an example of the many different types of functional arrangements that can be employed to implement the operation of the depicted portion of client application 248. As an alternative, the flowchart of FIG. 6 can be viewed as depicting an example of elements of a method implemented within the network environment 200.

Beginning with block 601, the client application 248 can identify a prompt request for a software development task. The client application 248 can identify the prompt request based at least in part on input received from the user interface 103. The developer service 241 can transmit data to the client application 248 for display the user interface 103 in association with integrated development functionality, security threat modeling functionality, diagramming functionality, and other suitable functionality.

In some examples, the prompt request can involve an instruction for evaluating selected source code for security vulnerabilities. In the user interface 103, the client application 248 can receive a selection of a portion of source code or an entire source code file. In response to identifying a security vulnerability, the prompt can involve generating secure code the addresses the identified security vulnerability. For example, the prompt can state “Please review the code in triple backticks for vulnerabilities.” In this example, the LLM service 243 can respond with “The code in triple backticks has a security vulnerability to SQL injection attacks. Here are modifications that add security controls for this vulnerability.”

In some examples, the prompt request can involve an instruction for generating an architecture diagram of a software application. The generations of application diagrams can include at least two types of prompts, such as generating diagrams from text and transforming or modifying an existing diagram. For instance, the generation of the diagrams from text. The prompt can state “Draw a diagram for a system that retrieves the user's transaction data from the accounts receivable system and returns the data in the body of a REST API request.”

Second, the prompt can request an instruction for transforming or altering an existing diagram. For instance, the prompt can state “Please add security controls for the component of this diagram that transmits the data to the third-party processing system.”

In some examples, the prompt request can involve linking a portion of the source code to a portion of architectural diagram of various components of the source code. The LLM service 243 can be trained on examples of code diagram pairs. The source code 124 can be annotated for matching a portion of the source code 124 to a portion of the application diagram. For instance, the prompt could state that “This code implements the ‘product_selection’ component of the diagram below.”

In block 604, the client application 248 can transmit a search query to a security data source 207 based at least in part on the software development task. The search query can be performed in order to retrieve security threat data 254 (e.g., relevant documents and data related to the software development task requested in the prompt). In some examples, the search query involves using a retrieval-augmented generation protocol.

In block 607, the client application 248 can receive the security threat data 254 from the security threat data 254 based at least in part on the search query for the prompt. The security data source 207 can transmit the relevant security threat data 254 based at least in part on a context of the prompt (e.g., the software development task) and/or the security code requirements 242. The received security threat data 254 can be in a format of an embedding (e.g., a numeric representation for a document, a data element, etc.) for a LLM associated with the LLM service 243.

In block 610, the client application 248 can augment the prompt by adding the security threat data 254 retrieved from the security threat data 254. In some examples, the retrieved security threat data 254 is displayed on the user interface 103 for the user to review. The user can select one of more data elements of the security threat data 254 retrieved from the security data source 207 to be removed so that they are not sent with the prompt to the LLM service 243.

In block 613, the client application 248 can transmit the augmented prompt to the LLM service 243. The LLM service 243 can generate a response based at least in part on the set of security threat data 254. The answer can be provided to the client application 248 for display in the user interface 103. For instance, the answer can include an architecture diagram, a secure source code, a security test case, or other related security software development tasks.

In block 616, the client application 248 can display the response from the LLM service 243 in the user interface 103. The response can be provided to the client application 248 for display in the user interface 103. For instance, the response can include an architecture diagram, a secure source code, a security test case, or other related security software development tasks.

In block 619, the client application 248 can determine whether another prompt has been identified for the LLM service 243. For example, the client application 248 can receive another prompt from the user interface 103. If there is another prompt, then the client application 248 can proceed to block 622. If there is not another prompt, then the client application 248 can proceed to the end.

In block 622, the client application 248 can transmit the other prompt to the LLM service 243 based at least in part on receiving the other prompt from the client application 248. The user of the client application 248 can interact in an iterative manner on a security software development task with the LLM service 243. For example, the LLM service 243 can provide a response with answer and/or questions that can generate additional prompt and/or entry of other data. The iterative manner of prompts and response can be used to generate the secure source code, an application diagram, other suitable tasks for meeting security code requirements 242.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagram of FIG. 4 and flowcharts of FIGS. 5 and 6 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagram of FIG. 4 and flowcharts of FIGS. 5 and 6 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagram of FIG. 4 and flowcharts of FIGS. 5 and 6 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
identify a prompt that requests generating secure source code for source code with a security vulnerability, the prompt comprising a security code requirement;
query a security data source for a security threat embedding based at least in part on the prompt, the security threat embedding being a numeric representation of a document which can be processed by a large language model;
receive the security threat embedding from the security data source;
generate an augmented prompt that includes the prompt and the security threat embedding;
transmit the augmented prompt to the large language model;
receive the secure source code from the large language model; and
import the secure source code into application source code in a software development environment.

2. The system of claim 1, wherein the prompt is a first prompt and the machine-readable instructions further cause the computing device to at least:
identify a second prompt that requests a creation of a security test case for the application source code based at least in part on the importation of the secure source code; and
transmit the second prompt to the large language model.

3. The system of claim 2, wherein the machine-readable instructions further cause the computing device to at least:
receive the security test case from the large language model; and
execute the security test case for the application source code based at least in part on the receiving the security test case from the large language model.

4. The system of claim 1, wherein the machine-readable instructions further cause the computing device to at least:
receive a confirmation from the large language model that the application source code has implemented the security code requirement; and
execute a commit operation for storing the application source code in a software repository based at least in part on the confirmation from the large language model.

5. The system of claim 1, wherein importing the secure source code into the application source code is initiated based at least in part on a selection of a user interface component on a user interface for the software development environment.

6. The system of claim 1, wherein the prompt comprises an image for describing the security code requirement.

7. The system of claim 1, wherein prompt comprises a diagram representing an architecture structure of the application source code.

8. A method, comprising:
identifying, by at least one computing device, a prompt that requests generating secure source code for source code with a security vulnerability, the prompt comprising a security code requirement;
querying, by the at least one computing device, a security data source for a security threat embedding based at least in part on the prompt, the security threat embedding being a numeric representation of a document which can be processed by a large language model;
receiving, by the at least one computing device, the security threat embedding from the security data source;
generating, by the at least one computing device, an augmented prompt that includes the prompt and the security threat embedding;
transmitting, by the at least one computing device, the augmented prompt to the large language model;
receiving, by the at least one computing device, the secure source code from the large language model; and
importing, by the at least one computing device, the secure source code into application source code in a software development environment.

9. The method of claim 8, wherein the prompt is a first prompt and the further comprising:
identifying, by the at least one computing device, a second prompt that requests a creation of a security test case for the application source code based at least in part on the importation of the secure source code; and
transmitting, by the at least one computing device, the second prompt to the large language model.

10. The method of claim 9, further comprising:
receiving, by the at least one computing device, the security test case from the large language model; and
executing, by the at least one computing device, the security test case for the application source code based at least in part on the receiving the security test case from the large language model.

11. The method of claim 8, further comprising:
receiving, by the at least one computing device, a confirmation from the large language model that the application source code has implemented the security code requirement; and
executing, by the at least one computing device, a commit operation for storing the application source code in a software repository based at least in part on the confirmation from the large language model.

12. The method of claim 8, wherein importing the secure source code into the application source code is initiated based at least in part on a selection of a user interface component on a user interface for the software development environment.

13. The method of claim 8, wherein the prompt comprises an image for describing the security code requirement.

14. The method of claim 8, wherein prompt comprises a diagram representing an architecture structure of the application source code.

15. A non-transitory, computer-readable medium, comprising machine-readable instructions that, when executed by a processor of a computing device, cause the computing device to at least:
identify a prompt that requests generating secure source code for source code with a security vulnerability, the prompt comprising a security code requirement;
query a security data source for a security threat embedding based at least in part on the prompt, the security threat embedding being a numeric representation of a security document which can be processed by a large language model;
receive the security threat embedding from the security data source;
generate an augmented prompt that includes the prompt and the security threat embedding;
transmit the augmented prompt to the large language model;
receive the secure source code from the large language model; and
import the secure source code into application source code in a software development environment.

16. The non-transitory, computer-readable medium of claim 15, wherein the prompt is a first prompt and the machine-readable instructions, when executed by the processor, further cause the computing device to at least:
identify a second prompt that requests a creation of a security test case for the application source code based at least in part on the importation of the secure source code; and
transmit the second prompt to the large language model.

17. The non-transitory, computer-readable medium of claim 16, wherein the machine-readable instructions, when executed by the processor, further cause the computing device to at least:
receive the security test case from the large language model; and
execute the security test case for the application source code based at least in part on the receiving the security test case from the large language model.

18. The non-transitory, computer-readable medium of claim 15, wherein the machine-readable instructions, when executed by the processor, further cause the computing device to at least:
receive a confirmation from the large language model that the application source code has implemented the security code requirement; and
execute a commit operation for storing the application source code in a software repository based at least in part on the confirmation from the large language model.

19. The non-transitory, computer-readable medium of claim 15, wherein importing the secure source code into the application source code is initiated based at least in part on a selection of a user interface component on a user interface for the software development environment.

20. The non-transitory, computer-readable medium of claim 15, wherein the wherein the prompt comprises an image for describing the security code requirement.
